(19) United States
(12) Patent Application Publication
(10) Pub. No.: US 2013/0320779 A1
(43) Pub. Date: Dec. 5, 2013

(54) POWER SUPPLY SYSTEM FOR SERVER

(71) Applicant: HON HAI PRECISION INDUSTRY CO., LTD., New Taipei (TW)

(72) Inventor: FENG-CHI YANG, New Taipei (TW)

(73) Assignee: HON HAI PRECISION INDUSTRY CO., LTD., New Taipei (TW)

(21) Appl. No.: 13/902,895

(22) Filed: May 27, 2013

(30) Foreign Application Priority Data
May 31, 2012 (CN) 2012101751846

(51) Int. Cl. H02J 4/00

(52) U.S. Cl. CPC H02J 4/00
USPC 307/145

(57) ABSTRACT

A power supply system for a server includes a power grid including a number of crisscrossed wires connected to a power source, and a connector. The connector includes a main body with first and second terminals, and a contact plate connected to the first terminal of the main body. The contract plate is also slidably pressed against the power grid to form an electrical connection. The server acquires power from the power grid through the connector.

### BACKGROUND

1. Technical Field

The present disclosure relates to a power supply system for a server.

2. Description of Related Art

Servers residing in a server room may acquire power through cables from outlets connected to a commercial power source. If the servers need to be rearranged in the server room, the cables may need to be unplugged then plugged in again, which is inconvenient and time-consuming.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of an embodiment of a power supply system for a server of the present disclosure, wherein the power supply system includes a power grid and a power supply module.

FIG. 2 is a schematic diagram of the power grid of FIG. 1.

FIG. 3 is a block diagram of the power supply module of FIG. 1.

### DETAILED DESCRIPTION

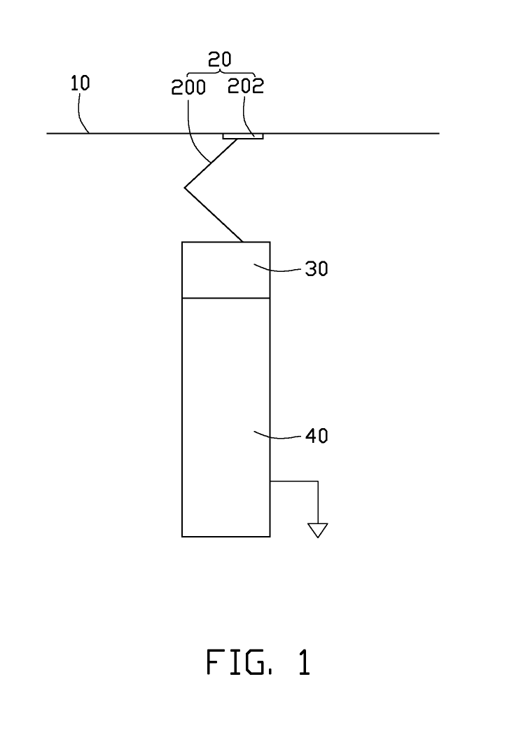

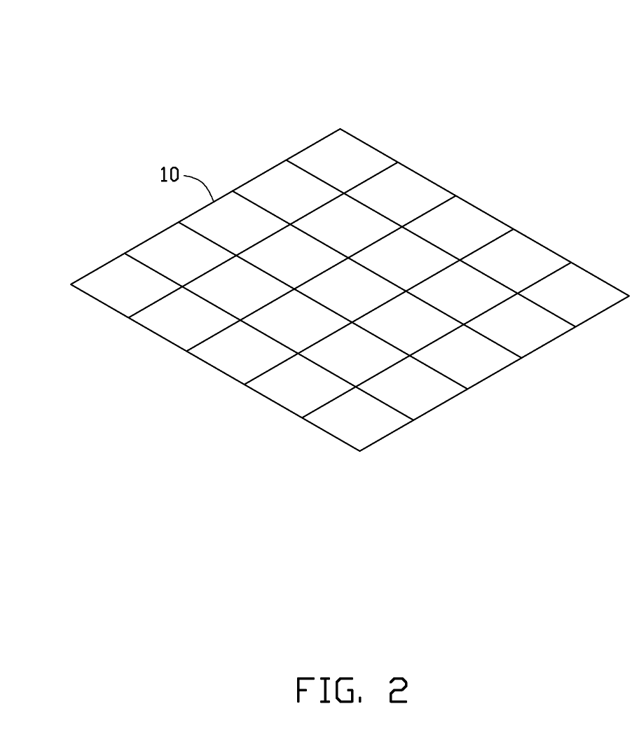

FIGS. 1 and 2 illustrate an embodiment of a power supply system of the present disclosure. The power supply system includes a power grid 10, a connector 20, a power supply module 30, and a server 40.

The server 40 includes a plurality of electronic elements, such as central processing units, memory modules, and power converters.

The power grid 10 is connected to a commercial power source, and includes a plurality of wires made of conductive material. In the illustrated embodiment, the wires are crisscrossed to form a grid of exposed metal, and other conductive objects can acquire power by electrically contacting the grid of exposed metal. In the illustrated embodiment, the power grid 10 is arranged above the server 40 in a server room.

The connector 20 includes a main body 200 with first and second terminals, and a contact plate 202 with top and bottom surfaces. The contact plate 202 is substantially rectangular, and is made of conductive material. The bottom surface of the contact plate 202 is connected to the first terminal of the main body 200, and the top surface of the contact plate 202 is electronically contacted to the power grid 10. In the illustrated embodiment, the main body 200 is substantially V-shaped.

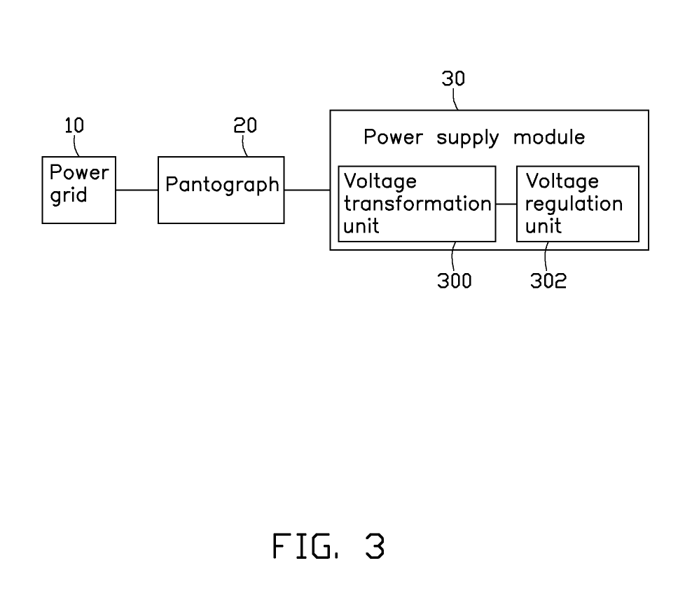

FIG. 3 shows that the power supply module 30 is slidably pressed against the power grid 10 by the connector 20 to establish an electrical connection between the power supply module 30 and the power grid 10. The power supply module 30 is arranged on the top of the server 40, and includes a voltage transformation unit 300 and a voltage regulation unit 302. The voltage transformation unit 300 is coupled to the second terminal of the main body 200, and is configured to transform the power from the power grid 10 to a transformed power suitable for the voltage regulation unit 302. The voltage regulation unit 302 is configured to receive the transformed power, and regulate the transformed power to provide power to electronic elements in the server 40. The power supply module 30 is also connected to ground through the server 40.

In another embodiment, if the power grid 10 is connected to a direct current power source, the server 40 can acquire power directly from the power grid 10 through the connector 20, because the direct current power from the power grid 10 can be converted into other power by a power converter of the server 40, such as 3 volts and 12 volts.

The server 40 can be towed automatically by other machine to move around in a server room utilizing the grid 10 without the need to unplug and plug in cables, because the contact plate 202 of the connector 20 is movably and electrically connected to the power grid 10.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power supply system for a server, comprising:
a power grid comprising a plurality of wires connected to a power source; and
a connector comprising a main body with first and second terminals, and a contact plate connected to the first terminal of the main body, wherein the contract plate is also movably and slidably pressed against to the power grid to form an electrical connection;
wherein the server acquires power from the power grid through the connector.

2. The power supply system of claim 1, further comprising a power supply module, wherein the power supply module comprises a voltage transformation unit and a voltage regulation unit, the voltage transformation unit is coupled to the second terminal of the main body, to acquire power from the power grid, and outputs a transformed power, the voltage regulation unit is configured to regulate the transformed power and provide regulated power to the server.

3. The power supply system of claim 2, wherein the connector is arranged over the server.

4. The power supply system of claim 3, wherein the power supply module is arranged on the top of the server, and the connector is arranged on the top of the power supply module.

5. The power supply system of claim 4, wherein the plurality of wires of the power grid is crisscrossed to form a grid structure.

6. The power supply system of claim 5, wherein the connector is substantially V-shaped.
